(19) United States
(12) Patent Application Publication
(10) Pub. No.: US 2004/0130627 A1
(43) Pub. Date: Jul. 8, 2004

(54) Triggering of image recordings

(76) Inventor: Ingolf Braune, Gundelfingen (DE)

Correspondence Address: HARNESS, DICKEY & PIERCE, P.L.C., P.O. BOX 828, BLOOMFIELD HILLS, MI, 48303, US

(21) Appl. No.: 10/668,112

(22) Filed: Sep. 22, 2003

(30) Foreign Application Priority Data
Sep. 23, 2002 (DE) 102 44 162.6

(51) Int. Cl. H04N 5/225

(52) U.S. Cl. 348/207.99

(57) ABSTRACT

The invention relates to a method for the triggering of an image recording by means of at least one camera system in which at least one part region of an image recording surface of the camera system is acted on by means of at least one radiation source in a non-recording state, the signal thereby derived from the image recording surface is supplied to an evaluation device and is evaluated as a non-recording signal and, on a change of the non-recording signal, the image recording is triggered automatically. The invention further relates to a camera system.

### CROSS-REFERENCE TO RELATED APPLICATIONS

This application claims priority to German Patent Application No. 102 44 162.6 filed Sep. 23, 2002, which application is herein expressly incorporated by reference.

### BACKGROUND OF THE INVENTION

The invention relates to a method for the triggering of an image recording by means of at least one camera system. The invention further relates to a camera system.

It is often desired in connection with image processing systems, such as are in particular used in automation engineering, but also in safety engineering, only to start the image recording when the object to be recorded is located at a pre-determined position relative to the camera system used and/or when specific pre-determined lighting conditions prevail. To obtain a trigger signal to start the image recording, it is known to provide a digital trigger input at the camera system to which a sensor can be connected which is a component of a light barrier or of a light scanner to detect a situation triggering the image recording and with which the respective desired optimum recording conditions can be detected. A further known procedure consists of carrying out a permanent sequence of image recording and to subsequently evaluate the images recorded.

The known methods for the automatic triggering of the image recording, i.e. for the automatic initiation of the image recording, however, have disadvantages since they are associated with a comparatively large technical measuring effort or—in the case of the permanent image recording—since recordings with insufficient quality can occur, as ultimately here only a random image recording takes place and a decision is only made on an evaluation of the images. Moreover, the required use of a powerful evaluation computer results in a high processing effort.

The known methods for the automatic triggering of the image recording, i.e. for the automatic initiation of the image recording, however, have disadvantages since they are associated with a comparatively large technical measuring effort or—in the case of the permanent image recording—since recordings with insufficient quality can occur, as ultimately here only a random image recording takes place and a decision is only made on an evaluation of the images. Moreover, the required use of a powerful evaluation computer results in a high processing effort.

In DE 101 19 498 C1, a possibility is described for the triggering of image recordings in which a CMOS image sensor including a plurality of sensor elements is provided and trigger data are supplied by a trigger region which is formed by a freely selected sub-set of sensor elements lying in the same row, said trigger data being checked for the presence of images of the objects to be recorded in a control device with the aid of pattern recognition processes. The generally present proneness to disturbances can be problematic here since it must be ensured that the objects to be recorded generally result in trigger data in which the respective images can be detected.

### SUMMARY OF THE INVENTION

It is the object of the invention to provide a possibility for the automatic triggering of image recordings which is characterized by high reliability, b<high trigger accuracy and by a low effort both with respect to the technical device demands and in the processing of image data.

This object is satisfied, on the one hand, by the features of the independent method claim and in particular in that at least one part region of an image recording surface of the camera system is acted on by means of at least one radiation source in a non-recording state, that the signal derived from an image recording surface is supplied to an evaluation device and is evaluated as a non-recording signal and that the image recording is triggered automatically on a change in the non-recording signal.

In accordance with the invention, the image recording surface is itself used as a trigger sensor, whereby an additional sensor can be dispensed with. It is furthermore of advantage that only a limited part region needs to be evaluated when the part region of the image recording surface is acted on, whereby a high sampling rate and thus a high trigger accuracy can be achieved. A further advantage consists of the fact that the position of the image section on the image recording surface serving as the trigger part region can generally be selected freely. The camera system can hereby be matched in a simple manner to the demands of the respective application. An adjustment and integration of additional components, in particular of separate sensors, is not necessary.

Since, in accordance with the invention, a trigger radiation source is used, the triggering of image recordings in accordance with the invention is generally independent of the objects to be recorded and thus particularly reliable with respect to disturbances in an advantageous manner. The evaluation device therefore does not have to look for the objects themselves, but only has to react to changes of a signal clearly defined by the trigger radiation source. By an appropriate shaping of the trigger beam, a beam spot of any desired geometrical shape can be produced on the image recording surface, said beam spot being independent of the objects to be recorded. The solution in accordance with the invention is hereby characterized by particularly high reliability. Due to the independence of the object in accordance with the invention, no measures are required which provide sufficient contrast between the background and the objects to be recorded during the non-recording state. In accordance with the invention, a permanent lighting of a monitored zone can hereby be dispensed with in accordance with the invention.

The object underlying the invention is moreover satisfied by the features of the independent apparatus claim and in particular in that the camera system includes at least one image recording surface, an evaluation device for the reading out of the image recording surface and at least one radiation source by means of which at least one part region of the image recording surface can be acted on in a non-recording state, with the evaluation device being made such that the signal originating from the part region of the image recording surface which is acted on is evaluated as a non-recording signal, a change in the non-recording signal being recognized and, when the non-recording signal is changed, a trigger signal being automatically presented for the triggering of an image recording.

Preferred embodiments of the invention are recited in the dependent claims, in the drawing and in the description.

For instance, in accordance with a particularly preferred embodiment of the invention, it is proposed that the propagation path of the radiation from the radiation source to the image recording surface extends through a monitored zone lying in the range of vision of the camera system. Moving objects which should be recorded by means of the camera system can hereby directly trigger their own recording in that they enter into the range of vision of the camera system and interact with the radiation passing through the monitored zone.

A preferred possibility for the triggering of the image recording consists of evaluating a displacement of the part segment on the image recording surface acted on by radiation from the radiation source as a change triggering the image recording.

A displacement of the part region on the image recording surface can take place, for example, in that the light scanner principle is used and the propagation path of the radiation is selected such that objects entering into a monitored zone of the camera system change the propagation path of the radiation such that admittedly radiation continues to reach the image recording surface, but the point of incidence of the radiation on the image recording surface is displaced with respect to the non-recording state. The evaluation device is made such that it detects this displacement and thereupon provides for the triggering of the image recording.

A further preferred possibility consists of evaluating the absence of the radiation incident on the part region of the image recording surface as a change triggering the image recording.

This can in particular be achieved in that the light barrier principle is used and the propagation path of the radiation is selected such that objects entering into a monitored zone of the camera system interrupt the propagation path of the radiation. In this case, the evaluation device recognizes that the part region on the image recording surface previously still acted on no longer delivers a signal, which is interpreted by the evaluation device as a change which results in the triggering of an image recording.

In a particularly preferred embodiment of the invention, the part region of the image recording surface to be acted on by means of the radiation source is pre-determined and only this part region is evaluated in the non-recording state. Comparatively little time is required for the evaluation of only the part region, whereby an advantageous increase in the sampling rate is made possible, which in turn results in an advantage increase in the trigger accuracy, since the occurrence of the condition triggering the image recording can be detected in real time.

It is furthermore proposed in accordance with the invention that the propagation path of the radiation from the radiation source to the image recording surface is adjustable. The point of incidence of the radiation on the image recording surface, and thus the position of the part region to be evaluated in the non-recording state, can hereby be freely selected in a simple manner. The setting of different propagation paths can take place, for example, by moving, in particular by pivoting, the radiation source relative to the image recording surface.

An illumination device can be used as the radiation source which is anyway present and which is also provided for the illumination of a monitored zone of the camera system. A separate trigger radiation source which serves exclusively to act on the part region of the image recording surface is thereby not required.

Provision can further be made for the triggering of the image recording to include the activation of an illumination device. The illumination which provides an optimum lighting of the recording zone can thus be activated, for example, simultaneously with the start of the image recording. The illumination device therefore does not have to be active in the non-recording state since the radiation source acting on the part region of the image recording surface is provided for the automatic triggering of the image recording.

It is proposed in accordance with a particularly preferred embodiment of the invention to use the signal obtained by acting on the part region of the image recording surface for the function check, in particular for the determination of the degree of contamination.

The signal made available by means of the radiation source is hereby moreover used to check the optical conditions in the propagation path of the trigger radiation. Contamination, e.g. by deposits, on the optical systems used results in a reduction in the intensity of the radiation acting on the part region of the image recording surface. A permanent monitoring of the functionality of the system can be ensured by evaluating the signal by means of the evaluation device or by means of a separate evaluation module and thus by monitoring the intensity of the radiation reaching the image recording surface.

The image recording surface of the camera system is preferably formed by a spatially resolving sensor. A CMOS, CCD or CID detector can, for example, be used for this. In accordance with the invention, any desired spatially resolving detectors can generally be used which are sensitive to the wavelengths of the radiation used.

Depending on the demands respectively required in practice, the trigger radiation source can be arranged spatially separated from the image recording surface or be integrated together with the image recording surface in a common unit. In the latter case, a unit is provided which is advantageously compact and which can be handled as a whole.

The geometrical shape of the radiation incident on the image recording surface and thus—at least approximately—the geometrical shape of the trigger part region of the image recording surface can generally be selected as desired. The trigger radiation can e.g. thus be imaged on the image recording surface in the form of an extended light spot or in a linear manner.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows schematically, in a side view, an embodiment of a camera system in accordance with the invention in which the light scanner principle is used;

FIGS. 2a and 2b are views in accordance with FIG. 1 of further embodiments of a camera system in accordance with the invention in which the light barrier principle is used;

FIG. 3 shows schematically, a perspective view of a camera system working according to the light scanner principle in accordance with a further embodiment of the invention; and

FIG. 4 shows schematically, a perspective view of a camera system working in accordance with the light barrier principle in accordance with a further embodiment of the invention.

### DETAILED DESCRIPTION OF THE PREFERRED EMBODIMENTS

The following description of the preferred embodiment(s) is merely exemplary in nature and is in no way intended to limit the invention, its application, or uses.

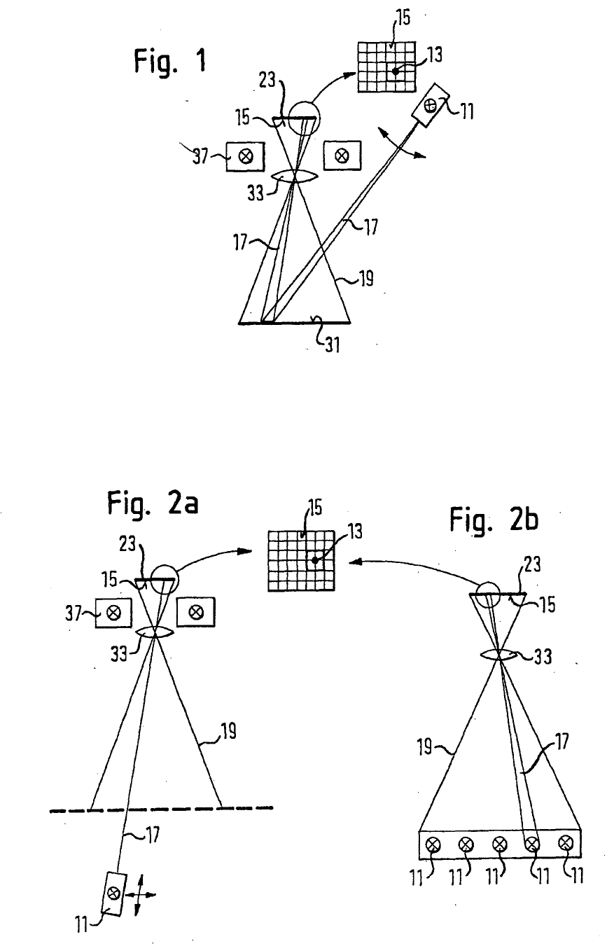

Of the camera system illustrated in FIG. 1, only an optical imaging system 33 indicated as a lens and a spatially resolving sensor 23 of the CMOS type are shown, the latter including a radiation-sensitive image recording surface 15 which is divided into a plurality of detection elements or pixels. An optical imaging device of generally any desired design, which e.g. includes an objective or a lens system, can be provided as the optical imaging system.

A radiation source 11 is furthermore provided whose wavelength is generally any desired one as long as the emitted radiation 17 can be detected by means of the sensor 23.

The camera system in accordance with FIG. 1 works in accordance with the light scanner principle and thus in accordance with the triangulation principle. The radiation 17 transmitted by the radiation source 11 is reflected at a reflection surface 31, which lies in a monitored zone visible to the camera, such that it is incident on the image recording surface 15 of the sensor 23, but only a comparatively small part region 13 of the image recording surface 15 is acted on or illuminated in the embodiment shown. The position of the part region 13 on the image recording area 15 depends on the relative arrangement of the radiation source 11 and of the image recording surface 15. As indicated by the double arrow 1 in FIG. 1, the radiation source 11 can be pivoted relative to the sensor 23, whereby the position of the part surface 13 on the image recording surface 15 can be changed.

The above-mentioned monitored zone 19 of the camera system can be congruent with the total range of vision of the camera which can be evaluated by means of the sensor 13; alternatively, however, it can also represent only a part region of the range of vision.

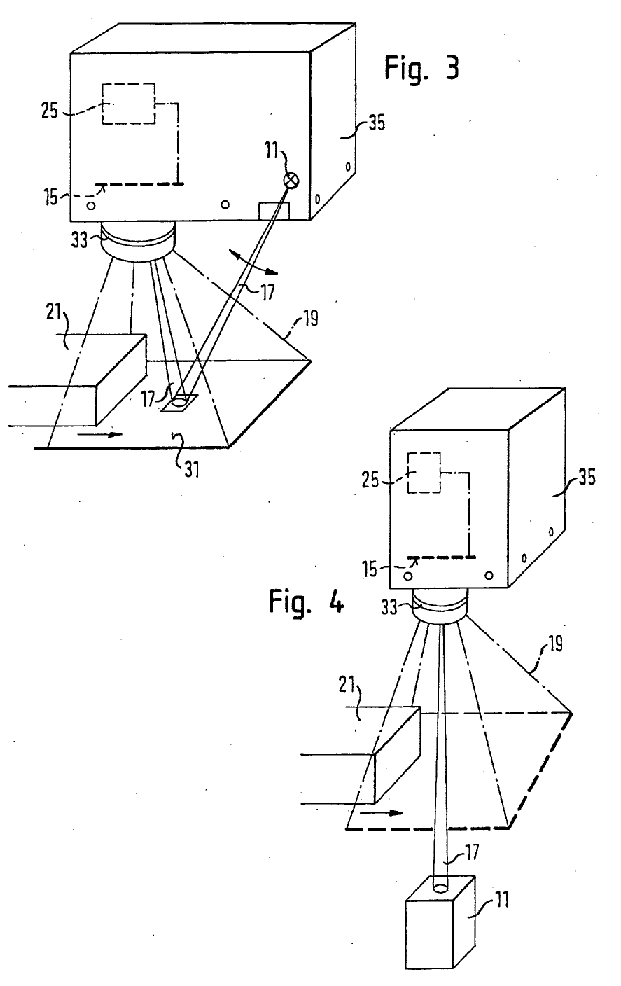

When an object to be recorded intrudes into the monitored zone 19 and enters into the propagation path of the radiation 17 between the radiation source 11 and the sensor 23, the radiation 17 is no longer reflected by the reflection surface 31, but rather by the object. The propagation path of the radiation 17, and thus the position of the part region 13 on the image recording surface 15, is thereby changed. In FIG. 3, such an object 21 is shown which has intruded into the monitored zone 19 and is approaching the propagation path of the radiation 17. In the situation shown in FIG. 3, the camera system is still in the non-recording state since the radiation 17 transmitted by the radiation source 11 is still reflected by the reflection surface 31 which is formed, for example, by a transport belt for the objects 21. As soon as the object 21 enters into the beam path between the radiation source 11 and the optical system 33 of the camera, the radiation 17 is reflected by the upper side of the object 21 elevated with respect to the reflection surface 31, whereby a displacement of the region of incidence (not shown in FIG. 3) of the radiation 17 on the image recording surface 15 of the camera sensor 23 results due to the triangulation principle.

An evaluation device 25 of the camera system in accordance with the invention only indicated in FIG. 3 is in a position to recognize this displacement of the trigger region 13 on the image recording surface 15 by means of a corresponding change of the output signal of the sensor 23 and to thereupon initiate image recording.

In the arrangement in accordance with FIG. 3, the radiation source 11 and the camera are arranged in a common housing 35, whereby a compact recording unit which can be handled as a whole results.

FIGS. 2a and 2b schematically show possibilities for automatic triggering in which the light barrier principle is used in each case. The relative arrangement of the radiation source 11 and of the image recording surface 15 of the sensor 23 in each case is selected such that an object entering into the beam path passing through the monitored zone 19 of the camera interrupts the propagation path of the radiation 17 from the radiation source 11 to the image recording surface 15, and indeed such that the radiation 17 is not reflected onto the image recording surface 15. The change taking place here of the signal originating from the trigger part region 13 on the image recording surface 15 consists of the absence of the signal as soon as the beam path is interrupted by the object. The evaluation unit 25 (cf. FIG. 4) is formed such that this absence of the non-recording signal is detected and the image recording is thereupon started. FIG. 4 shows the spatially separate arrangement of the radiation source 11 and of the image recording surface 15 at opposing sides of the monitored zone 19 of the camera system.

In the version of FIG. 2a, a single radiation source 11 is provided which is movable relative to the sensor 23 for the changing of the position of the trigger part region 13 on the image recording surface 15 of the sensor 23, as is indicated by the double arrow.

In the version shown in FIG. 2b, a plurality of radiation sources 11 are integrated into a support for the objects to be recorded. Depending on the respectively desired course of the trigger radiation 17 in the monitored zone 19 of the camera, one of the radiation sources 11 can be directly activated. Since the total image recording surface 15 of the sensor 23 is available for the small trigger part region 13, no readjustment of the camera system is required for such changes of the propagation path of the radiation 17.

The optical system 33 in the embodiment in accordance with FIG. 1 and FIG. 2a is surrounded by an illumination device 37 which is e.g. provided in the form of a flashlight ring which is activated on the triggering of the image recording in order, in this manner, only to provide an illumination of the monitored zone 19 when this is required for the recording of the respective object 21.

In all the above-described variants of the invention, the image recording surface 15, with which the actual image recordings of objects are carried out, is simultaneously used in an advantageous manner to make a trigger signal available in that a signal made available by evaluation of a part region 13 of the image recording surface 15 in the non-recording state is permanently checked for changes by means of an evaluation device 25 designed therefore. As soon as the respective pre-determined change conditions occurs, the image recording is triggered by means of the evaluation device 25, whereupon either the total image recording surface 15 or a pre-determined part region is read out for the carrying out of the actual image recording.

In order to avoid false triggering, provision can be made for displacements or intensity changes of the trigger part region 13 or of the trigger radiation 17 on the image recording surface 15 only to result in a starting of the image recording when the displacement or the intensity change exceeds a pre-determined tolerance limit.

The evaluation device 25 can moreover define the degree of contamination in the propagation path of the trigger radiation 17 by evaluating the part region 13 of the image recording surface 15 acted on by the trigger radiation source 11 in the non-recording state in order in this manner to carry out a function check and e.g. to make a warning signal available on the reaching of a pre-determined degree of contamination. Reference is made to the introductory part in this respect.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for the triggering of an image recording by means of at least one camera system, in which
at least one part region (13) of an image recording surface (15) of the camera system is acted on by means of at least one radiation source (11) in a non-recording state;
the signal hereby derived from the image recording surface (15) is supplied to an evaluation device (25) and is evaluated as a non-recording signal; and
the image recording is triggered automatically on a change of the non-recording signal.

2. A method in accordance with claim 1, characterized in that the propagation path of the radiation (17) from the radiation source (11) to the image recording surface (15) extends through a monitored zone (19) disposed in the range of vision of the camera system.

3. A method in accordance with claim 1, characterized in that a displacement of the part region (13) on the image recording surface (15) acted on by radiation (17) from the radiation source (11) is evaluated as a change triggering the image recording.

4. A method in accordance with claim 1, characterized in that the part region (13) of the image recording surface (15) is acted on in accordance with the light scanner principle such that the propagation path of the radiation (17) from the radiation source (11) to the image recording surface (15) is changed by objects (21) entering into a monitored zone (19) of the camera system.

5. A method in accordance with claim 1, characterized in that the absence of the radiation (17) incident on the part region (13) of the image recording surface (15) is evaluated as a change triggering the image recording.

6. A method in accordance with claim 1, characterized in that the part region (13) of the image recording surface (15) is acted on in accordance with the light barrier principle such that the propagation path of the radiation (17) from the radiation source (11) to the image recording surface (15) is interrupted by objects (21) entering into a monitored zone (19) of the camera system.

7. A method in accordance with claim 1, characterized in that the part region (13) of the image recording surface (15) to be acted on by means of the radiation source (11) is pre-determined and exclusively this part region (13) is evaluated in the non-recording state.

8. A method in accordance with claim 1, characterized in that the propagation path of the radiation (17) from the radiation source (11) to the image recording surface (15) is adjustable, in particular by a movement of the radiation source (11) relative to the image recording surface (15).

9. A method in accordance with claim 1, characterized in that at least a part of an illumination device that is present and provided for the lighting of a monitored zone of the camera system is used as the radiation source (11).

10. A method in accordance with claim 1, characterized in that the triggering of the image recording includes the activation of an illumination device (37).

11. A method in accordance with claim 1, characterized in that the signal obtained by acting on the part region (13) of the image recording surface (15) is used for the function check, in particular for the defining of the degree of contamination, with the intensity of the radiation acting on the part region (13) preferably being monitored for this purpose.

12. A method in accordance with claim 1, characterized in that a camera system is used in accordance with any one of the claims below.

13. A camera system comprising at least one image recording surface (15), an evaluation device (25) for the reading out of the image recording surface (15) and at least one radiation source (11) by means of which at least one part region (13) of the image recording surface (15) can be acted on in a non-recording state, with the evaluation device (25) being made such that the signal originating from the part region (13) of the image recording surface (15) acted on is evaluated as a non-recording signal, a change of the non-recording signal is recognized and, on a change of the non-recording signal, a triggering signal is generated automatically for the triggering of an image recording.

14. A camera system in accordance with claim 13, characterized in that the image recording surface (15) is formed by a spatially resolving sensor (23), in particular by a sensor of the CMOS, CCD or CID type.

15. A camera system in accordance with claim 13, characterized in that the radiation source (11) is movable relative to the image recording surface (15).

16. A camera system in accordance with claim 13, characterized in that the radiation source (11) is arranged spatially separated from the image recording surface (15).

17. A camera system in accordance with claim 13, characterized in that the image recording surface (15) and the radiation source (11) are integrated into a common unit.

18. A camera system in accordance with claim 13, characterized in that a display device is provided for the distinguishable display of the non-recording state and of the recording state.

19. A camera system in accordance with claim 13, characterized in that the triggering of the image recording takes place in accordance with a method in accordance with any one of claims 1 to 12.
